(19) United States
(12) Patent Application Publication
(10) Pub. No.: US 2015/0054704 A1
(43) Pub. Date: Feb. 26, 2015

(54) ANTENNA MODULE FOR TERMINAL DEVICE AND METHOD FOR MANUFACTURING THE SAME

(71) Applicant: Samsung SDI Co., Ltd., Yongin-si (KR)

(72) Inventor: Yu-Sik Hwang, Yongin-si (KR)

(73) Assignee: Samsung SDI Co., Ltd., Yongin-si (KR)

(21) Appl. No.: 14/226,782

(22) Filed: Mar. 26, 2014

Related U.S. Application Data
(60) Provisional application No. 61/869,479, filed on Aug. 23, 2013.

(51) Int. Cl. H01Q 7/00

(52) U.S. Cl. CPC H01Q 7/00
USPC 343/788; 343/866; 29/600

(57) ABSTRACT

An antenna module for a terminal device includes: a substrate; and a conductive coil on the substrate and having a first end at an outside of the conductive coil and a second end at an inside of the conductive coil, the conductive coil including: one or more loops; and a plurality of conductive strips extending from an innermost one of the one or more loops.

### CROSS-REFERENCE TO RELATED APPLICATION

This application claims priority to and the benefit of U.S. Provisional Application No. 61/869,479, filed on Aug. 23, 2013 in the U.S. Patent and Trademark Office, the entire content of which is incorporated herein by reference.

### BACKGROUND

1. Field

Embodiments of the present invention relate to an antenna module for a terminal device and a method for manufacturing the same.

2. Description of the Related Art

Near field communication (NFC) is a non-contact communication technology using a frequency band of 13.56 MHz as one of radio frequency identification (RFD) technologies.

Portable terminal devices perform functions including, for example, information exchanges between the terminal devices, payments, and searches, using the NFC technology. Accordingly, demand for NFC antenna devices used in the short range communication scheme is continuously increasing.

As shown in FIG. 1, an NFC radiation pattern 10 may include a loop pattern 11, and first and second power feeding terminals 12 and 13 electrically coupled, respectively, to outer and inner ends of the loop pattern 11.

The radiation pattern 10 may be stacked or layered on a ferrite sheet, and the ferrite sheet may block or reduce radio wave interference between the radiation pattern 10 and a printed circuit board (not shown) of a terminal device, thereby preventing or reducing degradation of antenna characteristics.

Generally, the ferrite sheet 102 is formed into a structure covering the entire surface of the radiation pattern 10.

Meanwhile, unlike the existing NFC frequency band, frequency specifications have a narrow range in low-bandwidth communication. Hence, when considering ferrite distribution, it may be difficult to meet desired frequency specifications, using the NFC antenna pattern described above.

### SUMMARY

Embodiments of the present invention provide the design of a new antenna pattern which may improve ferrite distribution as a factor having influence on a frequency bandwidth and adjust an LCR value in a pattern process.

Other aspects and characteristics of the embodiments of the present invention can be derived by those skilled in the art from the following embodiments.

According to an embodiment of the present invention, an antenna module for a terminal device includes: a substrate; and a conductive coil on the substrate and having a first end at an outside of the conductive coil and a second end at an inside of the conductive coil, the conductive coil including: one or more loops; and a plurality of conductive strips extending from an innermost one of the one or more loops.

One or more holes may be formed through the conductive strips starting from the conductive strip closest to the second end of the conductive coil.

The one or more holes formed at adjacent ones of the conductive strips may be offset such that the one or more holes do not overlap with each other.

The antenna module may be tuned by the holes to have a frequency specification within a desired range.

The conductive strips may be adapted for a portion to be removed.

The plurality of conductive strips may extend perpendicularly from the innermost one of the one or more loops.

The plurality of conductive strips may be parallel to each other.

The antenna module may further include first and second power feeding terminals at the first and second ends of the conductive coil, respectively.

The conductive coil may have a generally quadrilateral shape, and the first and second ends of the conductive coil and the plurality of conductive strips may be located at a same side of the conductive coil.

The conductive strips may be spaced apart from each other by concave patterns.

The substrate may be configured to reduce radio wave interference between the terminal device and the conductive coil.

The substrate may include a ferrite sheet.

A battery may include the antenna module located at an external surface of the battery.

According to another embodiment of the present invention, in a method for manufacturing an antenna module for a terminal device, the method includes: forming a conductive coil on a substrate, the conductive coil having a first end at an outside of the conductive coil and a second end at an inside of the conductive coil, the conductive coil including: one or more loops; and a plurality of conductive strips extending from an innermost one of the one or more loops.

The method may further include sequentially forming one or more holes through one or more of the conductive strips.

The method may further include forming the one or more holes through adjacent ones of the conductive strips in an order starting from the conductive strip closest to the second end of the conductive coil.

The method may further include measuring a frequency specification of the antenna module and sequentially forming the one or more holes through the conductive strips until the frequency specification of the antenna is within a desired range.

The method may further include sequentially forming the one or more holes through the adjacent ones of the conductive strips to be offset such that the holes do not overlap.

The method may further include forming the conductive coil in a generally quadrilateral shape with the first and second ends and the plurality of conductive strips being located at a same side of the conductive coil.

The substrate may include a ferrite material.

According to the present invention, it may be possible to improve ferrite distribution as a factor having influence on a frequency bandwidth and to adjust an LCR value in a pattern process.

Further, it may be possible to improve the yield of an antenna manufacturing process.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is view showing an NFC antenna device.

FIG. 2 is a view schematically showing an antenna module for a terminal device according to an embodiment of the present invention.

FIG. 3 is a flowchart illustrating a method for manufacturing the antenna module for the terminal device according to the embodiment of the present invention.

FIG. 4 is an enlarged view showing a plurality of guide patterns according to the embodiment of the present invention.

FIG. 5 is a front view showing the antenna module for the terminal device according to the embodiment of the present invention.

FIG. 6 is a view schematically showing a state in which at least one hole is formed in one or more among the plurality of guide patterns according to the embodiment of the present invention.

FIG. 7 is a view showing a state in which at least one hole is formed in one or more among the plurality of guide patterns according to another embodiment of the present invention.

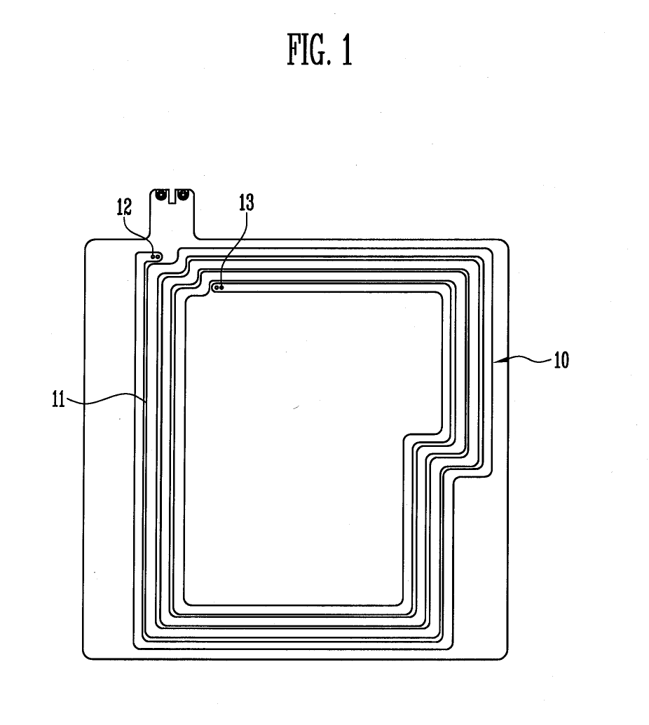

### DETAILED DESCRIPTION

In the following detailed description, exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” or “coupled to” another element, it can be directly connected or coupled to the other element or be indirectly connected or coupled to the other element with one or more intervening elements interposed therebetween. Hereinafter, like reference numerals refer to like elements.

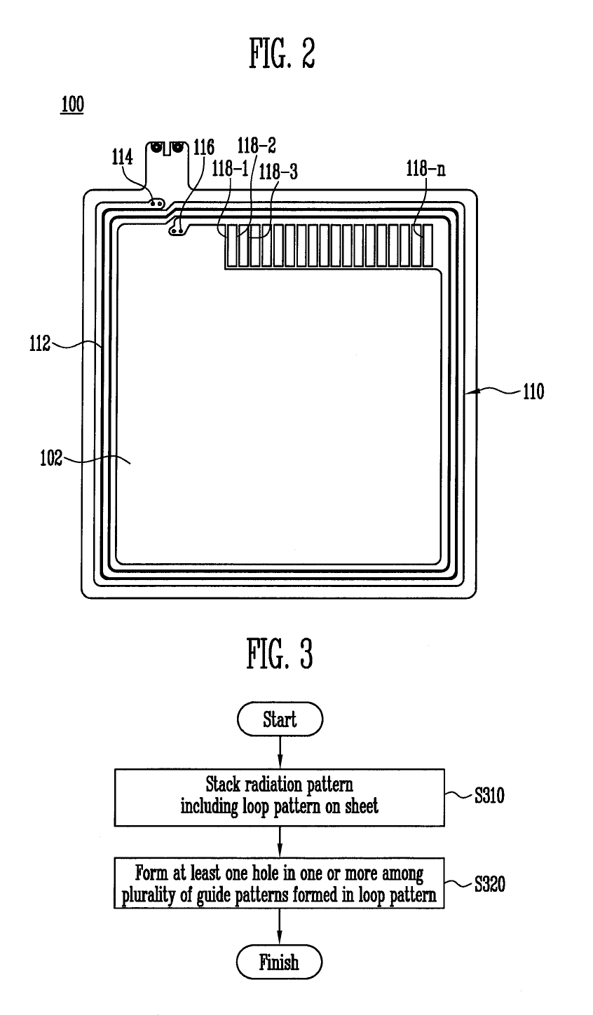

FIG. 2 is a view schematically showing an antenna module 100 for a terminal device according to an embodiment of the present invention.

FIG. 3 is a flowchart illustrating a method for manufacturing the antenna module for the terminal device according to the embodiment of the present invention.

As shown in FIGS. 2 and 3, the antenna module 100 for the terminal device includes a ferrite sheet or substrate 102 and a radiation pattern 110. The method for manufacturing the antenna module for the terminal device includes a step (S310) of stacking and a step (S320) of forming at least one hole.

More specifically, in step S310, the radiation pattern 110 including a loop or coil pattern is stacked or layered on the ferrite sheet 102.

In this case, the ferrite sheet 102 may perform a function of blocking or reducing radio wave interference between a printed circuit board of the terminal device and the radiation pattern 110 and amplifying a signal to extend the radius distance at which the signal can be received from an antenna.

In the present invention, it is assumed, for convenience of illustration, that the sheet performing the function is a ferrite sheet. However, the present invention is not limited thereto.

In the present invention, it is also assumed that the antenna module 100 is an antenna module for near field communication (NFC). However, the present invention is not limited thereto. That is, the antenna module 100 may be applied to other antennas in order to improve ferrite distribution and to adjust an LCR value in an antenna pattern process.

According to this embodiment, the radiation pattern 110 stacked or layered on the ferrite sheet 102 includes a loop or coil pattern 112, a first power feeding terminal 114 formed at an outer end of the loop pattern 112, and a second power feeding terminal 116 formed at an inner end of the loop pattern 112. That is, the conductive material of the loop pattern 112 is formed in a coil or spiral loop shape starting from a first end having the first power feeding terminal 114 and spiraling or coiling for one or more loops until the loop pattern 112 terminates at a second end having the second power feeding terminal 116.

Accordingly, the loop pattern 112 may be coupled to a printed circuit board of the terminal device (not shown) through the first and second power feeding terminals 114 and 116.

The radiation pattern 110 performs the function of an antenna that resonates in an NFC frequency band. That is, the radiation pattern 110 is formed with a flexible printed circuit board (FPCB) to perform the function of an antenna that resonates in a frequency band of about 13.56 MHz.

As described above, it may be difficult to secure desired frequency specifications, depending on the NFC radiation pattern. Thus, in this embodiment, a plurality of guide patterns 118 for forming one or more holes are formed in the loop pattern 112.

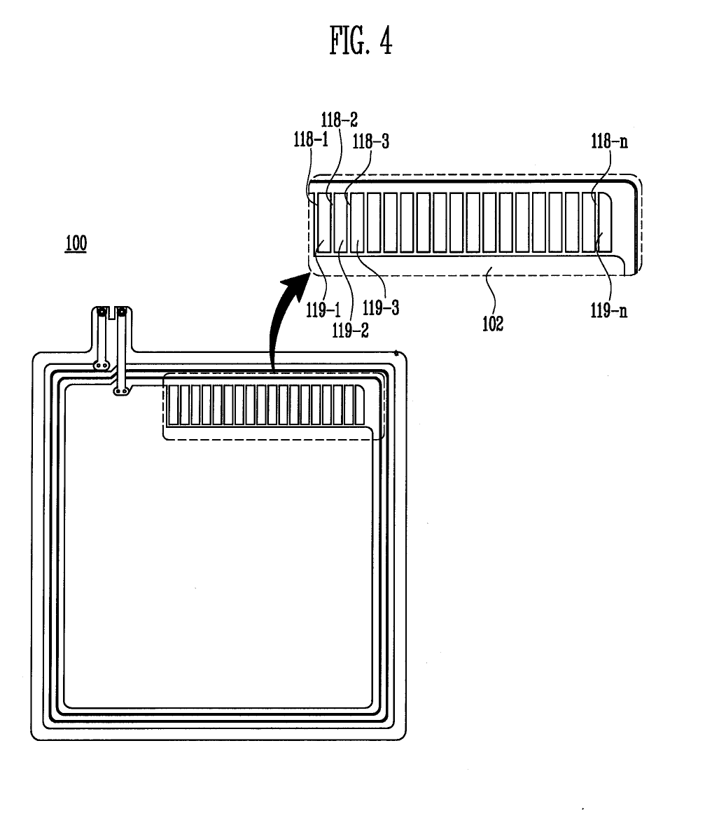

Hereinafter, the plurality of guide patterns 118-1 through 118-n according to this embodiment will be described in some detail with reference to FIGS. 2 and 4.

FIG. 4 is an enlarged view showing a plurality of guide patterns according to the embodiment of the present invention.

As shown in FIG. 4, the plurality of guide patterns 118-1 through 118-n are formed in the loop pattern 112 as a plurality of conductive strips extending from the loop pattern 112. That is, the guide patterns 118-1 through 118-n extend from the loop pattern 112 at an internal portion of the spiral or coil of the loop pattern 112. In one embodiment, the guide patterns 118-1 through 118-n extend perpendicular with respect to the coil of the loop pattern 112. Each of the guide patterns 118-1 through 118-n are coupled, at a first end, to the loop pattern 112, and extend in a direction generally toward the center of the spiral or coil of the loop pattern 112 for a suitable distance that may vary according to the design and function of the antenna module, and are coupled to each other at a second end opposite the first end. Each of the guide patterns 118-1 through 118-n may be arranged adjacent to each other near the second power feeding terminal 116. Each of the guide patterns 118-1 through 118-n may further extend parallel to each other, and one of a plurality of concave patterns 119-1 through 119-n may be positioned between each of the adjacent guide patterns 118-1 through 118-n. The plurality of guide patterns 118-1 through 118-n may be coplanar with or formed at a same layer as the coil of the loop pattern 112.

The plurality of guide patterns 118-1 through 118-n operate to facilitate forming one or more holes on the loop pattern 112. That is, the guide patterns 118-1 through 118-n are adapted for a portion to be removed such that at least one hole is formed in one or more among the plurality of guide patterns 118-1 through 118-n in step S320, described later, such that one or more holes are formed on the loop pattern 112.

The plurality of guide patterns 118-1 through 118-n are formed in the innermost loop among one or more loops constituting the loop pattern 112. The plurality of guide patterns 118-1 through 118-n are positioned or located adjacent to the second power feeding terminal 116 of the first and second power feeding terminals 114 and 116. For example, the guide patterns 118-1 through 118-n may be positioned along a same edge as the second power feeding terminal 116 on the loop pattern 112. That is, the plurality of guide patterns 118 may be located along the loop pattern 112 and adjacent (e.g., immediately adjacent) to the second power feeding terminal 116 formed at the inner end of the loop pattern 112. For example, the loop pattern 112 may have a quadrangular or quadrilateral loop shape, and the plurality of guide patterns 118 and the second power feeding terminal 116 may be positioned on one of four sides constituting the quadrangular or quadrilateral loop shape.

N guide patterns 118-1, 118-2, 118-3, . . . , 118-n constituting the plurality of guide patterns 118 according to this embodiment are consecutively arranged in a row at an interval (e.g., a predetermined interval). N concave patterns 119-1, 119-2, 119-3, . . . , 119-n for distinguishing the n guide patterns from one another respectively exist between the n guide patterns.

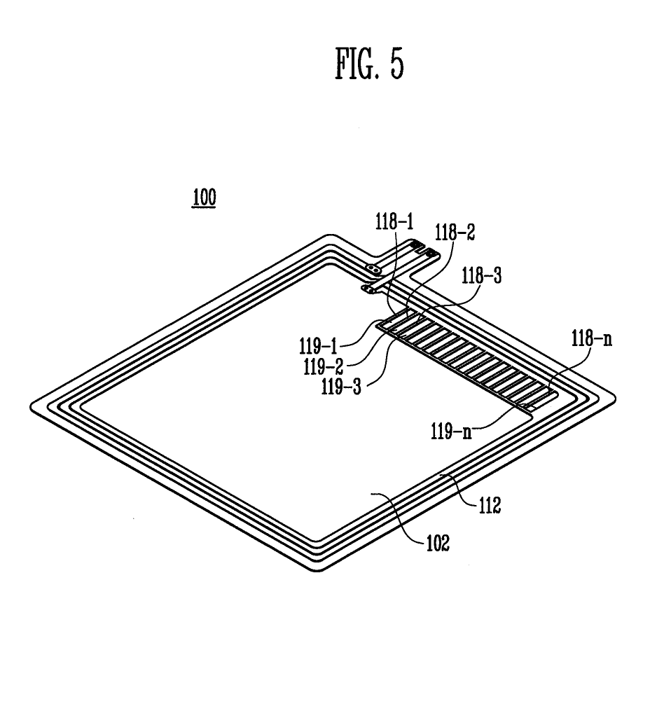

More specifically, FIG. 5 shows a front view of the antenna module 100 for the terminal device according to the embodiment of the present invention. As shown in FIG. 5, the n concave patterns 119-1, 119-2, 119-3, . . . , 119-n are respectively positioned between the n guide patterns 118-1, 118-2, 118-3, . . . , 118-n. In one embodiment, the n is equal to 18, however, the present invention is not limited thereto.

In this case, the height of the concave pattern 119 may be lower than that of the guide pattern 118 and the loop pattern 112. The guide pattern 118 and the concave pattern 119, collectively, may facilitate adjusting the flow of current in the radiation pattern and the fine adjustment of a frequency by forming holes through the guide pattern 118 or removing a portion of the guide pattern 118.

Accordingly, it may be possible to improve ferrite distribution as a factor having influence on a frequency bandwidth and to adjust an LCR value in a pattern process.

Hereinafter, a configuration in which the frequency is finely adjusted by forming at least one hole in the guide pattern 118 and controlling inductance and capacitance will be described with reference to FIGS. 3, 6, and 7.

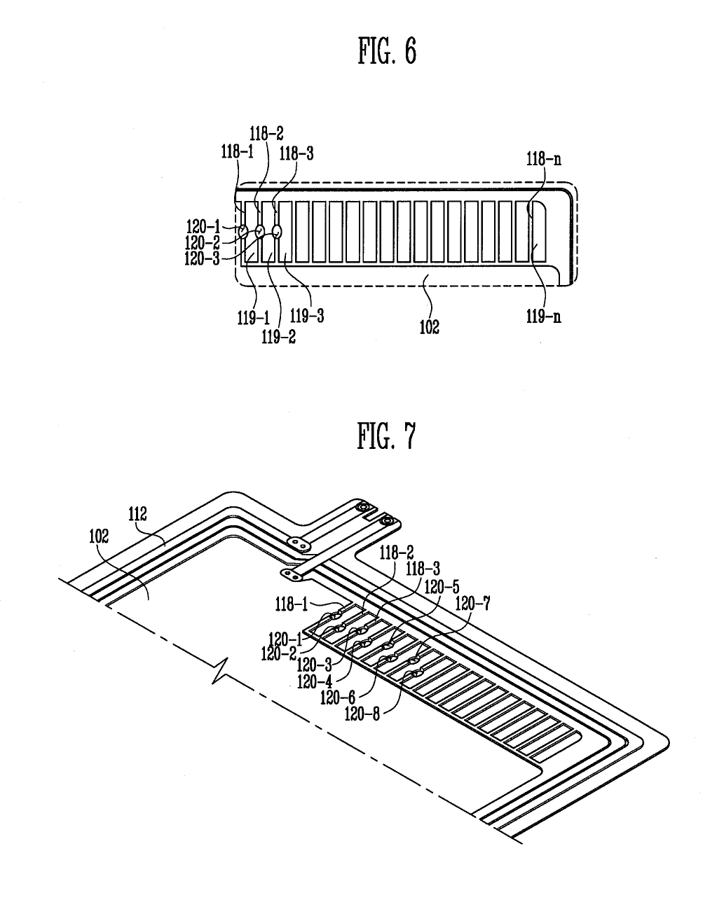

FIG. 6 is a view schematically showing a state in which one or more holes 120-1, 120-2 and 120-3 are formed in one or more among the plurality of guide patterns 118-1, 118-2, 118-3, . . . , 118-n in step S320 according to the embodiment of the present invention.

As shown in FIG. 6, in step S320, one or more holes are formed in one or more among the plurality of guide patterns 118 formed in the loop pattern 112 in order to form the one or more holes on the loop pattern 112.

In this case, it is possible to measure a frequency specification whenever one hole is formed in each of the plurality of guide patterns 118, and the holes are formed in the plurality of guide patterns 118 until a desired frequency specification (e.g., within a desired range) is derived.

FIG. 7 is a view showing a state in which at least one hole is formed in one or more among the plurality of guide patterns according to another embodiment of the present invention.

As one hole is formed in each of the plurality of guide patterns, the inductance decreases, and the capacitance increases. Thus, the fine adjustment of the frequency is possible.

The process of forming holes in the plurality of guide patterns 118 will be described in detail. In a case where the ferrite distribution is not satisfactory in the antenna pattern process, the frequency specifications are adjusted (e.g., reduced) by punching the plurality of guide patterns 118 one by one from the guide pattern close to the inner end of the loop pattern 112 among the n guide patterns 118-1, 118-2, 118-3, . . . , 118-n, i.e., the guide pattern 118-1 close to the second power feeding terminal 116.

In this case, the holes respectively formed in adjacent ones of the plurality of guide patterns 118-1 through 118-n may be formed to be offset from each other such that they do not to overlap with each other. That is, a hole in one of the guide patterns 118-1 through 118-n may be formed a first distance away from the final loop of the loop pattern 112, and another hole in an adjacent one of the guide patterns 118-1 through 118-n may be formed a second distance away from the final loop of the loop pattern 112, wherein the first and second distances are different.

To this end, in step S320, the holes have a size in which the holes respectively formed in the plurality of guide patterns are formed not to overlap with each other as shown in FIG. 6. For example, the hole may be formed with a size which is greater than the width of the guide pattern 118-1 and smaller than the width of the concave pattern 119-1.

As shown in FIG. 7, when the guide patterns 118 are punched one by one from the guide pattern 118-1 close to the second power feeding terminal 116, the punching is performed in a zigzag, so that the holes respectively formed in the plurality of guide patterns can be formed not to overlap with each other.

Meanwhile, the radiation pattern 110 is stacked on the ferrite sheet 102. Thus, as the holes are formed in one or more among the plurality of guide patterns 118, the holes are formed at corresponding positions in the ferrite sheet 102.

That is, the holes may be formed through a punching process. The holes may be holes passing or extending through the radiation pattern 110 and may also pass or extend through the ferrite sheet 102.

Although it has been described in the present invention that, for convenience of illustration, the stacked structure of the antenna module is configured with only the ferrite sheet 102 and the radiation pattern 110, an adhesive tape may be formed on and beneath the ferrite sheet. The radiation pattern (i.e., the FPCB) may be stacked on the adhesive tape, and a photo solder resist (PSR) ink may be applied on the radiation pattern 110.

Accordingly, the holes may pass completely through the ferrite sheet, the adhesive tape formed on and beneath the ferrite sheet, the radiation pattern, and the PSR ink.

As described above, according to the present invention, it is possible to improve ferrite distribution as a factor having influence on a frequency bandwidth and to adjust an LCR value in a pattern process. Further, it is possible to improve the yield of an antenna manufacturing process.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. An antenna module for a terminal device comprising:
a substrate; and
a conductive coil on the substrate and having a first end at an outside of the conductive coil and a second end at an inside of the conductive coil, the conductive coil comprising:
one or more loops; and
a plurality of conductive strips extending from an innermost one of the one or more loops.

2. The antenna module of claim 1, wherein one or more holes are formed through the conductive strips starting from the conductive strip closest to the second end of the conductive coil.

3. The antenna module of claim 2, wherein the one or more holes formed at adjacent ones of the conductive strips are offset such that the one or more holes do not overlap with each other.

4. The antenna module of claim 2, wherein the antenna module is tuned by the holes to have a frequency specification within a desired range.

5. The antenna module of claim 1, wherein the conductive strips are adapted for a portion to be removed.

6. The antenna module of claim 1, wherein the plurality of conductive strips extend perpendicularly from the innermost one of the one or more loops.

7. The antenna module of claim 1, wherein the plurality of conductive strips are parallel to each other.

8. The antenna module of claim 1, further comprising first and second power feeding terminals at the first and second ends of the conductive coil, respectively.

9. The antenna module of claim 1, wherein the conductive coil has a generally quadrilateral shape, wherein the first and second ends of the conductive coil and the plurality of conductive strips are located at a same side of the conductive coil.

10. The antenna module of claim 1, wherein the conductive strips are spaced apart from each other by concave patterns.

11. The antenna module of claim 1, wherein the substrate is configured to reduce radio wave interference between the terminal device and the conductive coil.

12. The antenna module of claim 11, wherein the substrate comprises a ferrite sheet.

13. A battery comprising the antenna module of claim 1 located at an external surface of the battery.

14. A method of manufacturing an antenna module for a terminal device, the method comprising:
forming a conductive coil on a substrate, the conductive coil having a first end at an outside of the conductive coil and a second end at an inside of the conductive coil, the conductive coil comprising:
one or more loops; and
a plurality of conductive strips extending from an innermost one of the one or more loops.

15. The method of claim 14, further comprising sequentially forming one or more holes through one or more of the conductive strips.

16. The method of claim 15, further comprising forming the one or more holes through adjacent ones of the conductive strips in an order starting from the conductive strip closest to the second end of the conductive coil.

17. The method of claim 16, further comprising measuring a frequency specification of the antenna module and sequentially forming the one or more holes through the conductive strips until the frequency specification of the antenna is within a desired range.

18. The method of claim 16, further comprising sequentially forming the one or more holes through the adjacent ones of the conductive strips to be offset such that the holes do not overlap.

19. The method of claim 14, further comprising forming the conductive coil in a generally quadrilateral shape with the first and second ends and the plurality of conductive strips being located at a same side of the conductive coil.

20. The method of claim 14, wherein the substrate comprises a ferrite sheet.
